(19) United States
(12) Patent Application Publication
(10) Pub. No.: US 2005/0210392 A1
(43) Pub. Date: Sep. 22, 2005

(54) Document creating method, document creating apparatus, program, recording medium, and document data structure

(76) Inventors: Masami Koide, Tokyo (JP); Akira Suzuki, Kanagawa (JP); Takefumi Hasegawa, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/084,836

(22) Filed: Mar. 17, 2005

(30) Foreign Application Priority Data
Mar. 17, 2004 (JP) NO. 2004-076030

(51) Int. Cl. G06F 3/00; G06F 17/21

(52) U.S. Cl. 715/751; 715/530

(57) ABSTRACT

A technique is disclosed for enabling collaborative creation of a document by plural persons. The collaborative document creation involves setting an editing method for a document created by a first terminal apparatus, setting an editing function for realizing the editing method to the document created by the first terminal apparatus, and disclosing to a second terminal apparatus the document created by the first terminal apparatus with the editing function set thereto.

The present application is based on and claims the benefit of the earlier filing date of Japanese Patent Application No. 2004-076030 filed on Mar. 17, 2004, the entire contents of which are hereby incorporated by reference.

### BACKGROUND OF THE INVENTION

1. Field of the Invention

The present invention relates to a document creating method, a document creating apparatus, a program, a recording medium, and a document data structure.

2. Description of the Related Art

Oftentimes a user (creator) creates a document or a program according to a work process flow as is described below. First, the user (creator) creates a document or a program and edits the document until the creator feels that the document has reached a certain level of completion. Then, the user submits the document to a supervisor who checks the document. Then, the user edits the document once more based on remarks and corrections made by the supervisor. According the work process flow as is described above, a document or a program may be created without notable problems when the user (creator) understands what kind of document the supervisor (checker) is demanding. However, when there is a misunderstanding on the creator's side and a document is created that is significantly different from what the supervisor (checker) has in mind, the supervisor (checker) has to make significant changes to the document created by the user (creator), this being a burden on the supervisor's side, and the user (creator) has to make extensive edits on his/her document based on instructions and advice from the supervisor, this being a burden on the user's side. In such a case, in addition to creating a burden on both the user (creator) and the supervisor (checker), psychological stress may also be created on both parties involved.

Accordingly, in recent years and continuing, various techniques are being developed for enabling a creator and a checker to create and edit work such as a document in a collaborative manner so as to reduce the burden of both the creator and the checker. Examples of such prior art techniques are described below.

Japanese Laid-Open Patent Publication No. 2000-020508 discloses a system for collaboratively editing work through monitoring the work of other users (creators). This system enables a user to view the edits of other users as reference or guidance, for example.

Japanese Laid-Open Patent Publication No. 5-028138 discloses a document editing system enabling plural users to edit the same section of a document. According to this system, plural users may edit a document while referring to edits of other users to avoid inconsistencies and contradictions.

Japanese Laid-Open Patent Publication No. 5-113975 discloses a collaborative document processing system for indicating the section of a document to be changed and comments with regard to the changes to be made to the document.

Japanese Laid-Open Patent Publication No. 5-135056 discloses a collaborative writing aid apparatus for updating a document through transmitting and receiving differences (changes) between an original document and an edited document to/from a collaborating editor.

Japanese Laid-Open Patent Publication No. 6-004534 discloses a collective writing document system for realizing exclusive access control of a document to enable plural persons to edit one piece of document.

Japanese Laid-Open Patent Publication No. 6-295299 discloses an electronic editing system for dividing a document into pages to enable plural persons to conduct editing on one piece of document.

Japanese Patent No. 3170950 (Publication No. 6-301676) discloses a document managing apparatus that manages and displays changes made by respective users (creators) regarding a group of documents subject to collaborative editing. This document managing apparatus attaches attributes pertaining to user information so that objectives of edits and changes on a document may be managed.

Japanese Laid-Open Patent Publication No. 8-202688 discloses a collaborative document creating apparatus that realizes exclusive access control of a document to enable reading of a collaborative editing section of a document that is to be collaboratively created by plural users. This collaborative document creating apparatus provides a document region that may be edited by all users involved in the creation of a particular document.

Japanese Laid-Open Patent Publication No. 11-306173 discloses a collaborative work aid system for enabling plural editors to edit a shared document by providing access to edits and changes made by other users (editors).

However, the various techniques disclosed in the prior art for enabling collaborative creation and editing of work such as a document are still incomplete and have various problems that need to be resolved.

For example, according to the techniques disclosed in the above prior art documents, a user (creator) is unable to change the degree of interference from editing. That is, the techniques according to the prior art are limited to controlling editing authority or viewing authority, for example.

Also, it is noted that in order to reduce the burden of both the creator and checker of a document, a system is demanded for enabling a checker to check a document being created by a creator from an early stage. However, in practice, there is a conscience on the creator's side of not wanting to disclose his/her work until reaching a certain level of completion. Thus, a system for enabling early disclosure of a work in progress is not established in the prior art.

### SUMMARY OF THE INVENTION

A document creating method, a document creating apparatus, a program, a recording medium and a document data structure. In one embodiment, a document creating method is disclosed for collaboratively creating a document by a plurality of persons using a plurality of terminal apparatuses that are interconnected via a network, the method comprises setting a disclosure condition for disclosing a document created at a first terminal apparatus of the terminal apparatuses to a second terminal apparatus of the terminal apparatuses; setting an editing method for the document created at the first terminal apparatus; setting an editing function for realizing the editing method to the document created at the first terminal apparatus; and disclosing to the second terminal apparatus the document created by the first terminal apparatus with the editing function set thereto when the disclosure condition is satisfied.

### BRIEF DESCRIPTION OF THE DRAWINGS

FIG. 1 is a diagram showing an example of a configuration of a document creating system according to an embodiment of the present invention;

FIG. 2 is a block diagram showing a hardware structure of a personal computer used in the document creating system according to the present embodiment;

FIG. 3 is a diagram illustrating an operation of an OS implemented in the personal computer;

FIG. 4 is a flowchart illustrating a process flow from the creation to completion of a document in a collaborative document creating process according to an embodiment of the present invention;

FIG. 5 is a block diagram showing functional parts of an editing function providing process of the collaborative document creating process according to the present embodiment;

FIG. 6 is a flowchart illustrating a process flow from the creation to automatic disclosure of a document in the collaborative document creating process according to the present embodiment;

FIG. 7 is a diagram showing an example of a form of a dialog for prompting a document creator to designate a disclosure condition;

FIG. 8 is a diagram showing an example of a form of a dialog for prompting the document creator to designate an editing method;

FIG. 9 is a flowchart illustrating a process flow of a conflict avoiding process in a collaborative document editing process according to an embodiment of the present invention;

FIG. 10 is a diagram illustrating document synchronization realized between a document at the document creator's side and a document at a collaborative creator's side;

FIG. 11 is a diagram illustrating an example of a method of avoiding conflict in a collaborative document editing process according to the present embodiment;

FIG. 12 is a diagram showing another example of a configuration of a document creating system according to an embodiment of the present invention;

FIG. 13 is a flowchart illustrating a process flow from the creation to completion of a document in a collaborative document creating process realized in a server-client system according to an embodiment of the present invention;

FIG. 14 is a diagram showing an example of a configuration of an encapsulated document including program files for realizing a document transmitting function and a document editing function according to an embodiment of the present invention;

FIG. 15 is a diagram showing an example of a content of a document file included in the encapsulated document according to the present embodiment;

FIG. 16 is a diagram illustrating document synchronization realized between document files included in the encapsulated document at the document creator's side and the encapsulated document at the collaborative creator's side, respectively, in a case where the document creator edits the document content; and

FIG. 17 is a diagram illustrating document synchronization realized between document files included in the encapsulated document at the document creator's side and the encapsulated document at the collaborative creator's side, respectively, in a case where the collaborative creator edits the document content.

### DETAILED DESCRIPTION

Accordingly, embodiments of the present invention reduce the burden of a creator and a checker upon realizing collaborative creation of a document by plural persons.

One embodiment of the present invention to enable sharing and creation of a document in a flexible manner upon realizing collaborative creation of a document by plural persons.

According to an embodiment of the present invention, a document creating method is provided for collaboratively creating a document by a plurality of persons using a plurality of terminal apparatuses that are interconnected via a network, the method including setting a disclosure condition for disclosing a document created at a first terminal apparatus of the terminal apparatuses to a second terminal apparatus of the terminal apparatuses; setting an editing method for the document created at the first terminal apparatus; setting an editing function for realizing the editing method to the document created at the first terminal apparatus; and disclosing to the second terminal apparatus the document created by the first terminal apparatus with the editing function set thereto when the disclosure condition is satisfied.

According to another embodiment of the present invention, a document creating method is provided for collaboratively creating a document by a plurality of persons using a plurality of terminal apparatuses that are connected via a network, the method including setting a disclosure condition for disclosing a document created at a first terminal apparatus of the terminal apparatuses to a second terminal apparatus of the terminal apparatuses; and disclosing the document created at the first terminal apparatus to the second terminal apparatus when the disclosure condition is satisfied.

According to another embodiment of the present invention, a document creating method is provided for collaboratively creating a document by a plurality of persons using a plurality of terminal apparatuses that are connected via a network, the method including setting an editing method for a document created at a first terminal apparatus of the terminal apparatuses; setting an editing function for realizing the editing method to the document created at the first terminal apparatus; and disclosing to a second terminal apparatus of the terminal apparatuses the document created at the first terminal apparatus with the editing function set thereto.

According to an embodiment of the present invention, the document creating method of the present invention may be realized using a server-client system including a server and a plurality of clients that are connected to the server.

According to another embodiment of the present invention, a document creating apparatus is provided that is connected to a terminal apparatus via a network in a network system and is adapted to realize collaborative creation of a document by a plurality of persons, the document creating apparatus including: a disclosure condition setting unit that sets a disclosure condition for disclosing a created document to the terminal apparatus; an editing method setting unit that sets an editing method for the created document; and an editing function setting unit that sets an editing function for realizing the editing method to the created document.

According to another embodiment of the present invention, a document creating apparatus is provided that is connected to a terminal apparatus via a network in a network system and is adapted to realize collaborative creation of a document by a plurality of persons, the document creating apparatus including: a disclosure condition setting unit that sets a disclosure condition for disclosing a created document to the terminal apparatus.

According to another embodiment of the present invention, a document creating apparatus is provided that is connected to a terminal apparatus via a network in a network system and is adapted to realize collaborative creation of a document by a plurality of persons, the document creating apparatus including: an editing method setting unit that sets an editing method for a created document; and an editing function setting unit that sets an editing function for realizing the editing method to the created document.

According to an embodiment of the present invention, the document creating apparatus of the present invention may be connected to a server via the network along with the terminal apparatus.

According to another embodiment of the present invention, a computer-readable program is provided that is run on a computer implemented in a document creating apparatus that is connected to a terminal apparatus via a network in a network system and is adapted to realize collaborative creation of a document by a plurality of persons, the program being executed by the computer to perform a method comprising: setting a disclosure condition for disclosing a created document to the terminal apparatus; setting an editing method for the created document; and setting an editing function for realizing the editing method to the created document.

According to another embodiment of the present invention, a computer-readable program is provided that is run on a computer implemented in a document creating apparatus that is connected to a terminal apparatus via a network in a network system and is adapted to realize collaborative creation of a document by a plurality of persons, the program being executed by the computer to perform a method comprising: setting a disclosure condition for disclosing a created document to the terminal apparatus.

According to another embodiment of the present invention, a computer-readable program is provided that is run on a computer implemented in a document creating apparatus that is connected to a terminal apparatus via a network in a network system and is adapted to realize collaborative creation of a document by a plurality of persons, the program being executed by the computer to perform a method comprising: setting an editing method for a created document; and setting an editing function for realizing the editing method to the created document.

According to another embodiment of the present invention, a storage medium is provided that stores a program of the present invention.

According to another embodiment of the present invention, a data structure of an encapsulated document is provided that includes a program of the present invention, a document file of a created document, and a program for viewing the document file.

In the following, preferred embodiments of the present invention are described with reference to the accompanying drawings.

1. Document Creating System

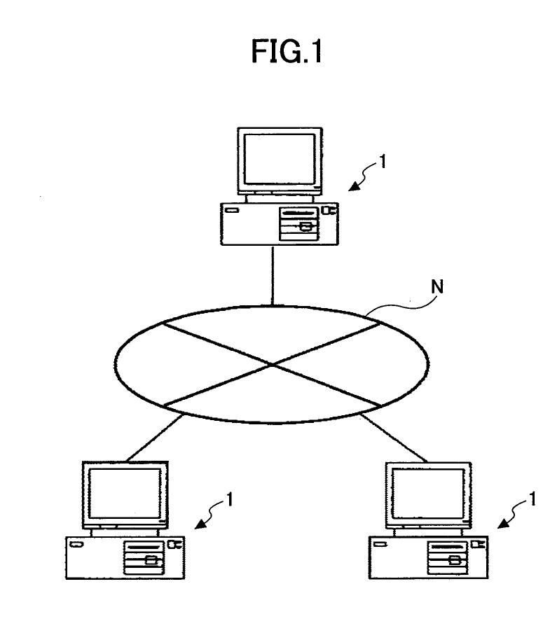

FIG. 1 is a diagram showing an exemplary configuration of a document creating system according to an embodiment of the present invention.

In the examples described below, it is assumed that the document creating system of the present embodiment corresponds to a network system including plural terminal apparatuses such as personal computers 1 (simply referred to as ‘computer’ hereinafter) that are connected through peer-to-peer connection via a network N such as a LAN (Local Area Network).

2. Computer Structure

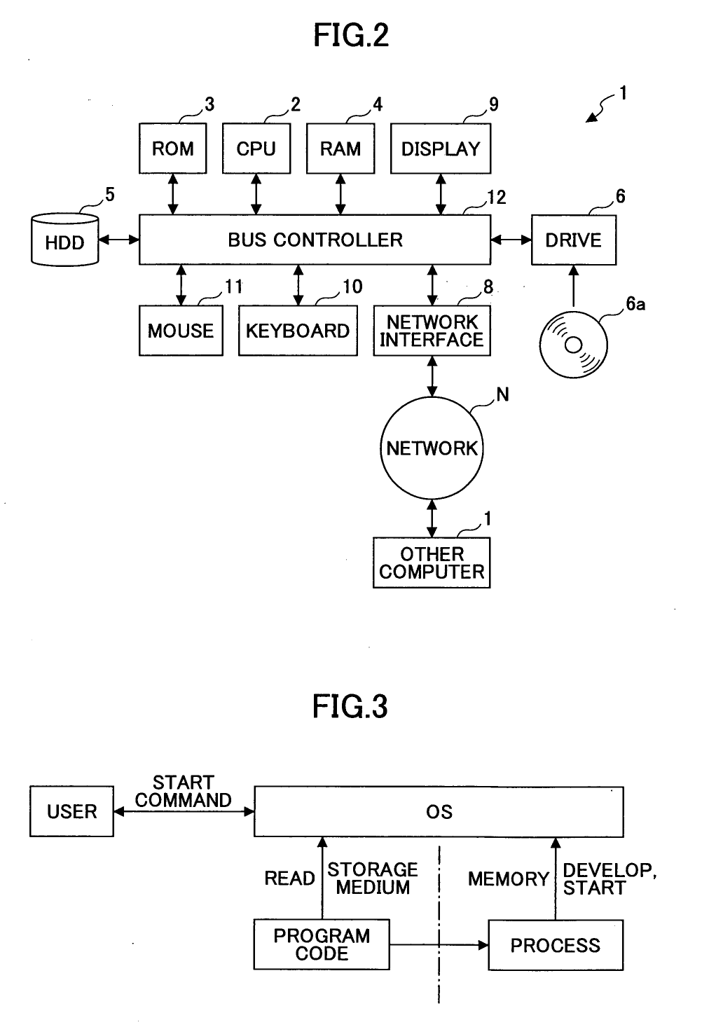

FIG. 2 is a block diagram showing a hardware configuration of a personal computer. The computer 1 shown in FIG. 2 includes a CPU (Central Processing Unit) 2 for processing information processing, a ROM (Read Only Memory) 3 storing programs such as a BIOS (Basic Input Output System), a primary storage unit such as a RAM (Random Access Memory) 4 for temporarily storing data during information processing, a secondary storage unit such as a HDD (hard disk drive) 5 for storing application programs and processing results, a drive 6 for a removable medium 6a corresponding to a recording medium for storing or distributing information outside or accessing information such as application programs from outside, a network interface 8 for establishing connection with a network to enable communication with other external computers 1, a display 9 that displays a process being conducted or a processing result to a user, input devices such as keyboard 10 and a mouse 11 for enabling a user to input information and commands to the computer 1, and a bus controller 12 for administering data communication between the respective components of the computer 1.

It is noted that the removable medium 6a may correspond to a flexible disk, a hard disk, a magnetic recording medium such as a magnetic tape, a magneto-optic recording medium such as an MO, an optical recording medium such as a CD, a CD-ROM, a CD-R, a CD-RW, a DVD-ROM, a DVD-R, a DVD-RAM, a DVD-RW, or a DVD+RW, a semiconductor memory, for example.

To realize data transmission at the computer 1, data is sent to the network interface 8 in response to which the network interface 8 outputs a signal to the network N. As for receiving data at the computer 1, the network interface 8 receives a signal from the outside and determines whether the received data signal is relevant. If it is determined that the received data signal is relevant, the data signal is downloaded to the computer 1, and if it is determined that the received data signal is irrelevant, the data signal is discarded. In other words, data transmission/reception at the computer 1 is realized via the network interface 8.

In the computer 1 having the configuration as is described above, generally, when a power switch is turned on by a user, the CPU 2 starts a program referred to as a loader that is included in the BIOS stored in the ROM 3, and downloads a program referred to as an operating system (OS) for controlling the operations of hardware and software components of the computer 1 from the HDD 5 to the RAM 4. The OS supports various operations such as starting an application program according to an operation by the user, reading information, and storing information. It is noted that Windows (registered trade mark of Microsoft Corporation) and UNIX (registered trademark of X/Open, Inc.) are representative examples of such an OS, and programs running on the OS are referred to as application programs. Generally, a user starts a specific application program through the OS, and conducts operations such as data editing, storing, and erasing, for example, on digital information stored in a storage unit a file. In other words, application programs and data on which a user conducts various operations are handled as files, and these files are stored in a storage unit of the computer 1.

FIG. 3 is a block diagram illustrating the operation of the OS for starting an application program stored in a storage medium such as the secondary storage unit of a computer in response to a command issued by the user. When the user issues a command to the OS to start a specific program, the OS reads the corresponding program code from the storage medium using hardware of the storage unit, and develops the program code at the RAM 4 corresponding to the primary storage unit (memory) of the computer 1. Then, the CPU executes the corresponding program according to a specific address developed at the RAM 4. Generally, a program that is individually executed in the manner described above is referred to as a ‘process’ or a ‘task’ to distinguish such programs from the ‘program code’ stored in the storage medium.

Generally, an OS is provided with a multi-task function for running plural tasks or processes simultaneously. In such a case, an individual memory region may be assigned to each process in order to enable plural processes to be run on the computer 1 at the same time.

Also, according to an embodiment, a virtual file referred to as a meta-file may be formed on the memory for realizing communication for exchanging data between processes of the computer 1, and information transmission/reception may be realized via File Access.

3. Collaborative Document Creating Process

In the following, a collaborative document creating process that is executed by the computer 1 is described. It is noted that the document creating process corresponds to one of plural computational processes that may be executed according to application programs operated on the OS by the CPU 2 of the computer 1. According to an embodiment, the collaborative document creating process enables plural users to collaboratively conduct operations such as creating, viewing editing, and revising of an office document or program, for example.

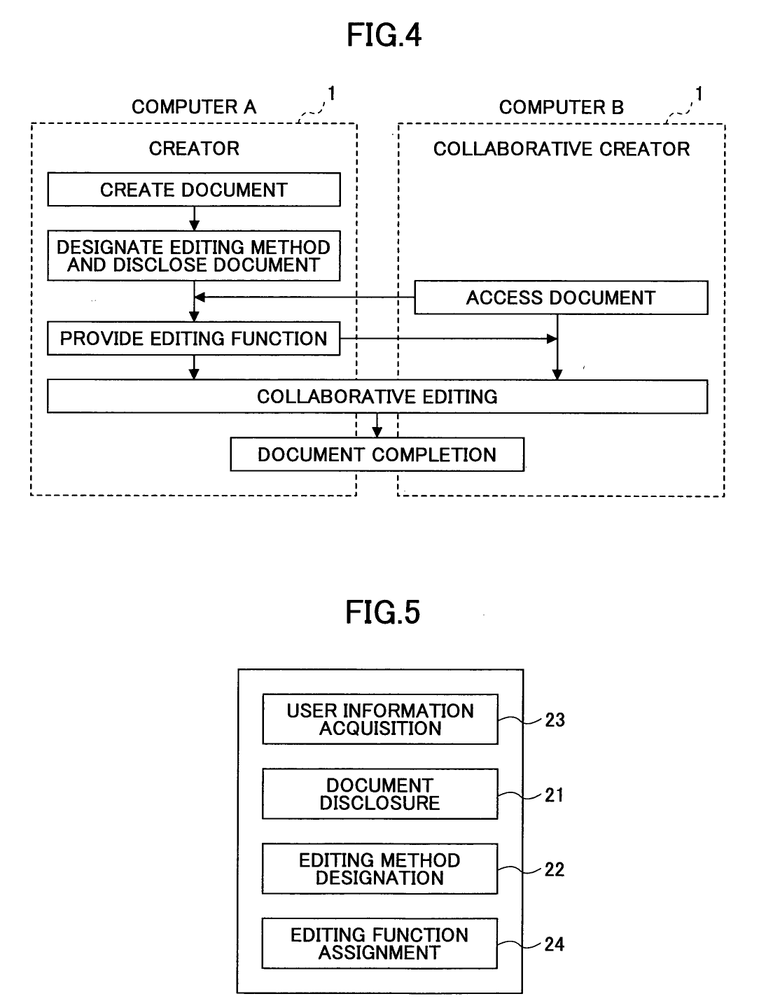

FIG. 4 is a flowchart illustrating an exemplary process flow of a collaborative document creating process from the creation of a document to its completion, the process being realized according to an application program operated on the OS by the CPU 2 of the computer 1.

According to the example of FIG. 4, a creator creates a document using a computer 1 (computer A) as a document creating apparatus, and designates an editing method upon disclosing the created document. When a collaborative creator accesses the disclosed document using a computer 1 (computer B), the computer 1 (computer A) of the creator provides the computer 1 (computer B) of the collaborative creator with an editing function that is designated by the creator. Accordingly, the collaborative creator uses the editing function provided by the computer 1 (computer A) to edit the document at the computer 1 (computer B). It is noted that normally, the creator and the collaborative creator conduct editing operations with full control. In this way, a document is collaboratively created, edited, and completed.

3-1. Document Disclosing Process, Editing Function Providing Process

FIG. 5 is a functional block diagram illustrating a document disclosing process and an editing function providing process of the collaborative document creating process according to an embodiment of the present invention. As is shown in FIG. 5, the computer 1 realizes document disclosure 21, editing method designation 22, user information acquisition 23, and editing function assignment 24 according to one or more application programs operated on the OS by the CPU 2.

The document disclosure 21 involves disclosing a document to a collaborative creator or a viewer so that the document may be shared and edited by plural persons. As for the disclosure method, a so-called ‘shared folder’ may be used in the Windows OS, and/or a document may be forwarded to a shared folder of another computer 1, for example.

The editing method designation 22 involves designating an editing method to be used by a collaborative creator. For example, an ‘editing method’ may be designated from options including ‘viewing only’, ‘tag attachment’, ‘comment insertion’, ‘content addition’, ‘full control’, and combinations thereof.

In the editing method designation 22, an editing method for each editor or collaborative creator may be designated according to the user information acquisition 23. The user information acquisition 23 involves acquiring user information of a collaborative creator. For example, various forms of user ID are provided for enabling access to various resources on the network N. In a Windows network N, the so-called Active Directory is a representative example such user ID. Other forms of user ID include e-mail addresses, Notes ID, and ID for browsing the Internet, for example. By accessing such user information, the user information acquisition 23 acquires user information of a collaborative creator. In a case where such user information cannot be acquired, a user ID and a password may be generated as user information, and the generated user ID and password may be conveyed to the collaborative creator via transmission means such as e-mail.

The editing function assignment 24 involves providing a collaborative creator with an editing function for editing a document disclosed by the document disclosure 21 when the disclosed document is accessed by the collaborative creator. The editing function is assigned to the collaborative creator according to the editing method designated by the editing method designation 22.

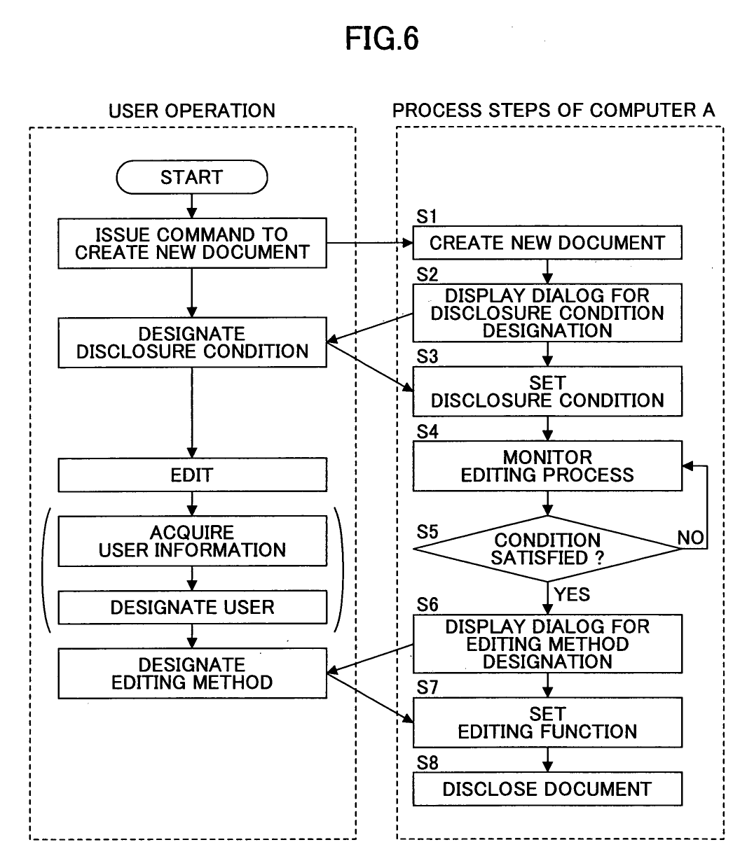

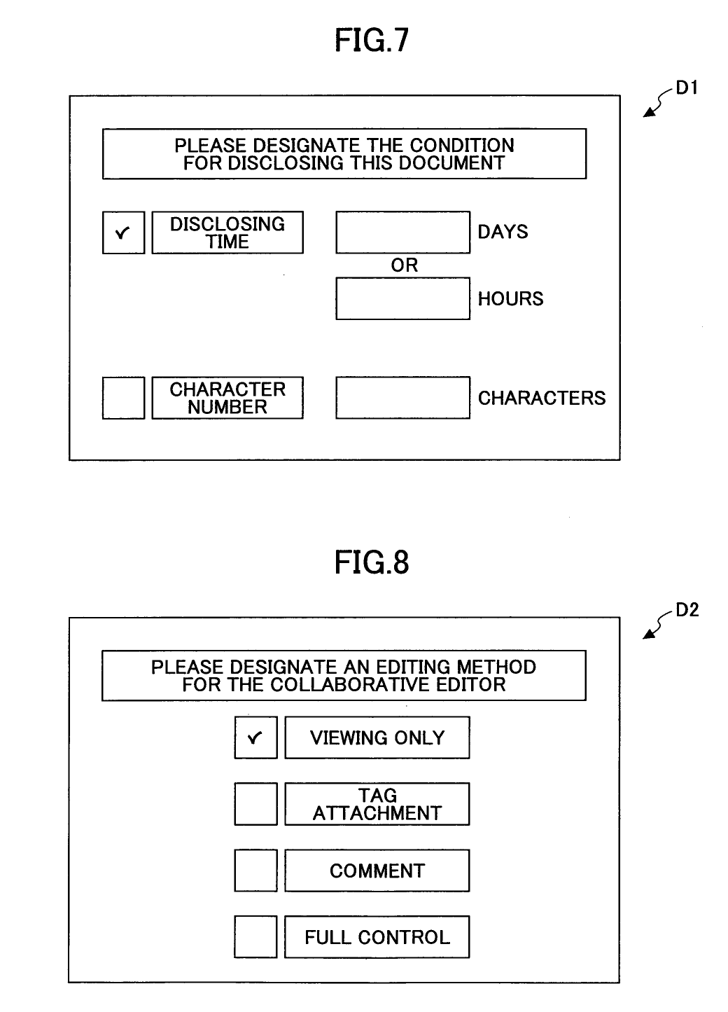

FIG. 6 is a flowchart illustrating a process flow from document creation to automatic disclosure of the created document in the collaborative document disclosing process. It is noted that in the left hand column of FIG. 6, operations of the user (creator) are shown, and in the left hand column of FIG. 6, process steps executed by the computer 1 (computer A) being used by the user (creator) are shown. According to the illustrated example of FIG. 6, when a document creator directs the computer 1 (computer A) to create a new document, the computer 1 (computer A) creates a new document (step S1), and displays on a display 9 a dialog D1 (see FIG. 7) for prompting the document creator to designate a disclosure condition (step S2).

For example, the number of days/hours or the number of characters may be designated as the disclosure condition in the dialog D1. FIG. 7 illustrates an exemplary form of the dialog D1 that enables selection of either the number of days/hours or the number of characters as the disclosure condition through clicking a corresponding checkbox with a mouse 11. In the case where the number of days/hours is selected as the disclosure condition, the number of days or the number hours for disclosing the document may be input through a keyboard 10. For example, the number of days for disclosing the document may be set to three days in which case the corresponding document may be automatically disclosed after three days from the time the disclosure condition is set. In another example, 1000 characters may be set as the disclosure condition in which case the corresponding document may be automatically disclosed after reaching 1000 characters.

When the document creator designates the disclosure condition, the computer 1 (computer A) sets the designated disclosure condition (step S3), and monitors the disclosure condition setting to determine whether the disclosure condition designated by the creator is satisfied (step S4).

Upon determining that the disclosure condition is satisfied as a result of editing processes conducted by the document creator, for example (step S5, Y), the computer 1 (computer A) displays on the display 9 a dialog D2 (see FIG. 8) for prompting the document creator to designate an editing method for the corresponding document (step S6). For example, ‘viewing only’ for only allowing viewing of the document, ‘tag attachment’ for allowing tag attachment to the document, ‘comment insertion’ for allowing comment insertion into the document, or ‘full control’ for allowing operations including deletion of contents, editing, and addition of contents on the document may be designated as the editing method in the dialog D2. FIG. 8 shows an exemplary form of the dialog D2 that enables selection of an editing method through clicking a corresponding checkbox with a mouse 11.

As is described above, upon designating the editing method, user information may be acquired to designate an editing method for each collaborative creator according to the acquired user information. In this case, an editing method may be flexibly set for each collaborative user by acquiring user information, identifying the corresponding user information of the user to which the document may be disclosed, and designating an editing method to be assigned to the identified collaborative user. It is noted that in a case where user information pertaining to one or more groups of users is acquired, an editing method may be designated according to the user group information, for example.

When the document creator designates the editing method to be assigned to one or more collaborative creators in the manner described above, the computer 1 (computer A) sets an editing function according to the editing method designated by the document creator via the dialog D2 (step S7) and discloses the document (step S8) to enable collaborative editing of the document As for the disclosure method, for example, the so-called ‘shared folder’ in a Windows environment may be used, and/or the document may be forwarded to another ‘shared folder’.

It is noted that the designation of the disclosure condition and the editing method may be conducted at any given timing, and the designated setting may also be changed.

Also, as is described above, when user information cannot be acquired, a user ID and a password may be generated, and the generated user ID and password may be conveyed to a collaborative creator via transmission means such as e-mail. It is noted that by describing the location of the disclosed document upon conveying the generated user ID and password to the collaborative creator, the collaborative user may easily access the disclosed document.

Also, as is described above, according to an embodiment, when a collaborative creator (user) accesses a disclosed document, the computer 1 (computer A) provides an editing function to the computer 1 (computer B) of this user according to the editing method designated for this user by the document creator. In such a case, the designated editing method for the user (collaborative creator) accessing the disclosed document may be conveyed to the user in order to avoid confusion as to the editing method that the user is authorized to use.

According to an embodiment of the present invention, when a disclosure condition for a document that is designated by a document creator is satisfied, the document is automatically disclosed so that the document may be revealed to a collaborative creator (checker) at an early stage and a system for early disclosure of a document to a checker may be established. Through early disclosure of a document to a checker, for example, when the document is written in a wrong manner, such an error may be detected at an early stage in order to reduce corrections on the document. In this way, the burden of both the document creator and the checker may be reduced.

According to an embodiment of the present invention, the document creator is able to control/change the allowed level of interference of a document editing/correcting process to be conducted by a collaborative creator through selecting a suitable editing method out of editing methods of various levels including ‘viewing only’, ‘tag attachment’, ‘comment insertion’, ‘content addition’, and ‘full control’, for example. According to one specific example, a project manager may intervene in a collaborative document creating process by attaching tags to a document, and document creators that are given editing authority may create and edit the document based on the attached tags. The degree of editing authority assigned to each document creator may be set according to the qualification or ability of each document creator, for example. Also, the degree of interference allowed to one or more users other than the document creator may be designated depending on the usage of the document. In this way, a document may be shared and created in a flexible manner.

3-2. Collaborative Editing Process

In the following, a collaborative editing process of the collaborative document creating process is described.

In a case where plural document creators collaboratively edit a document, edits made by the plural collaborative creators may conflict with each other. In other words, plural collaborative creators may edit or change the layout of the same section of a document at the same time, for example. Accordingly, a collaborative editing process according to an embodiment of the present invention includes a conflict avoiding process for avoiding conflict in a case where editing is simultaneously conducted by plural document creators.

It is noted that editing according the present embodiment includes editing without changing the layout or contents of a document by attaching tags and annotations to the document, and editing under full control in which the layout and contents of the document may be changed.

First, a conflict avoiding process in the editing process using annotations or tags is described below. A section of a document to which an annotation is attached may be subject to content change and/or layout change, or the section may be moved to another location or deleted. When the content of the section to which an annotation is attached is changed or deleted as is described above, the annotation is deleted. However, if the annotation is simply deleted, it may not be possible to determine what kind of annotation has previously been attached. Accordingly, for example, a ‘deletion list’ is provided for storing the deleted annotation along with the content (section) to which the annotation is directed so as to enable reproduction of the annotation and its corresponding section content. When the section content is moved to another location due to layout change of the document, the annotation may be moved to the new location of the corresponding section content. In order to maintain the link between an annotation and its corresponding section content, the section content needs to be recorded at the time the annotation or tag is attached. It is noted that the section content to which an annotation or tag is directed may correspond to an object in the form of a text (e.g., one or more words, phrases, or sentences) or an image, for example. An annotation may also be directed to an entire page, for example, in which case the corresponding content of the annotation may not be clear. In such a case, the page to which the annotation is attached may be recorded as its corresponding content. When lines or portions of a page are shifted or moved due to layout change, for example, the annotation directed to such a page may be deleted and the deleted annotation may be registered in the ‘deletion list’ along with its corresponding page content information.

Next, a conflict avoiding process in the editing process under full control is described. That is, a method is described for avoiding conflict between edits made by plural collaborative creators that are given authority to change the contents and the layout of a document.

In the collaborative editing process according to the present embodiment, text, still images, and/or moving images within a document are handled as objects, and editing may be conducted with respect to each object. It is noted that the text of a document may be subdivided into paragraphs, sentences or phrases according to indents, punctuation marks, and periods, and each subdivided text may be arranged to correspond to an object.

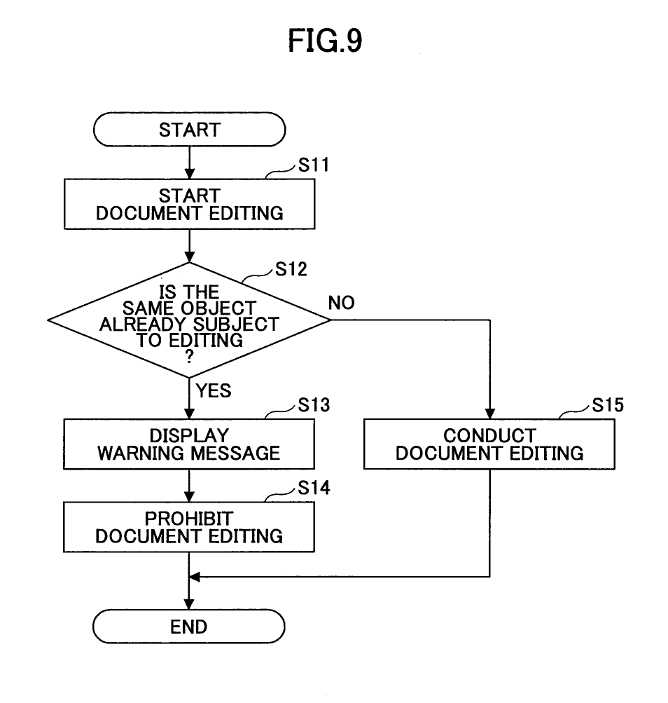

FIG. 9 is a flowchart showing a process flow of a conflict avoiding process according to an embodiment of the present invention. According to the illustrated example of FIG. 9, when a document creator starts editing a given object of a document (step S11), and it is determined that the same object is being edited by another document creator (step S12, Y), for example, a warning message “Currently being edited by XX” may be displayed on the display 9 (step S13) so as to prevent plural document creators from editing the same object of a document at the same time. It is noted that editing of an object of a document may be started by setting a cursor to the document using the mouse 11, or entering a word or character using the keyboard 10, for example.

After displaying the warning message, a process for prohibiting the editing of the object is conducted (step S14), and the operation is ended.

On the other hand, when it is determined that the object on which a document creator starts an editing operation does not correspond to the same object as that being edited by another document creator (step S12, N), the document editing operation on the object is accepted (step S15). According to the present embodiment, document editing may be simultaneously conducted on a document by plural document creators as long as the objects being edited by the respective document creators do not correspond to the same object. It is noted that since a large number of objects (e.g., text and/or images) are included in a document, it is not very likely for the same object of a document to be edited at the same time. Thus, by controlling editing operations in terms of object units, simultaneous editing of a document by plural document creators may be realized.

It is noted that an editing operation of an object may be ended when the object is changed by the mouse 11 or the keyboard 10, when a saving operation is executed by the mouse 10 or the keyboard 11, or when a new page is generated by the mouse 10 or the keyboard 11, for example.

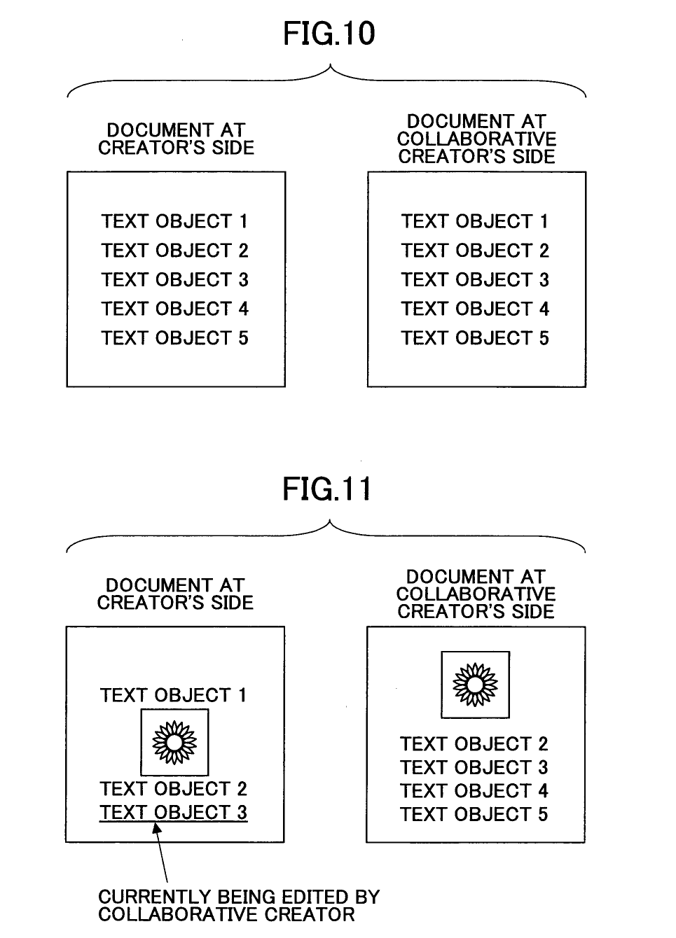

FIG. 10 illustrates a case in which document creation at a document creator side and document creation at a collaborative document creator side are synchronized. FIG. 11 illustrates a case in which the document creator inserts an image object O while the collaborative document creator is editing a text object 3. According to the present example, although synchronization of the document itself is realized, the display of the document at the collaborative document creator side is arranged such that the text object 3 being edited by the collaborative document creator may not be hidden as a result of the insertion of the image object O by the document creator. By realizing display of the document the manner described above, a document creator may be able to concentrate on the editing operation that he/she is conducting without being distracted by editing operations conducted by other collaborative document creators.

4. Modified Example of Document Creating System

It is assumed in the above-described embodiment that the document creating system is realized by plural computers 1 that are connected by a network N through peer-to-peer connection. However, the present invention is not limited to such an embodiment, and for example, the document creating system may also be realized by a server-client system in which plural client computers (simply referred to as ‘client’ hereinafter) C are connected to a server computer (simply referred to as ‘server’ hereinafter) S via a network N.

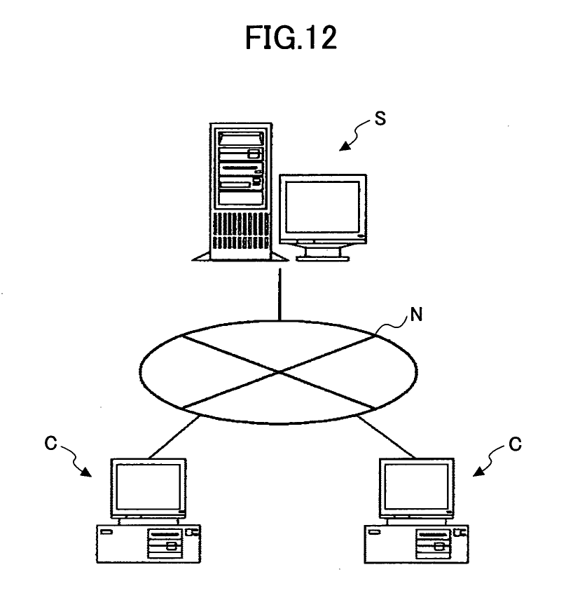

FIG. 12 is a diagram illustrating an exemplary configuration of a server-client system according to an embodiment of the present invention. In the server-client system of the present embodiment, the server S corresponds to a computer that conducts services for the client C, and the client C corresponds to a computer that receives services from the server S according to operations conducted by a user. According to an embodiment, the server S and the client C both correspond to personal computers 1 of the previously described embodiment, and the server S and the client C are arranged to realize their respective functions by application programs and data stored in their respective HDD 5. In other words, the server S and the client C are distinguished by the difference in the programs and data stored in their respective HDD 5.

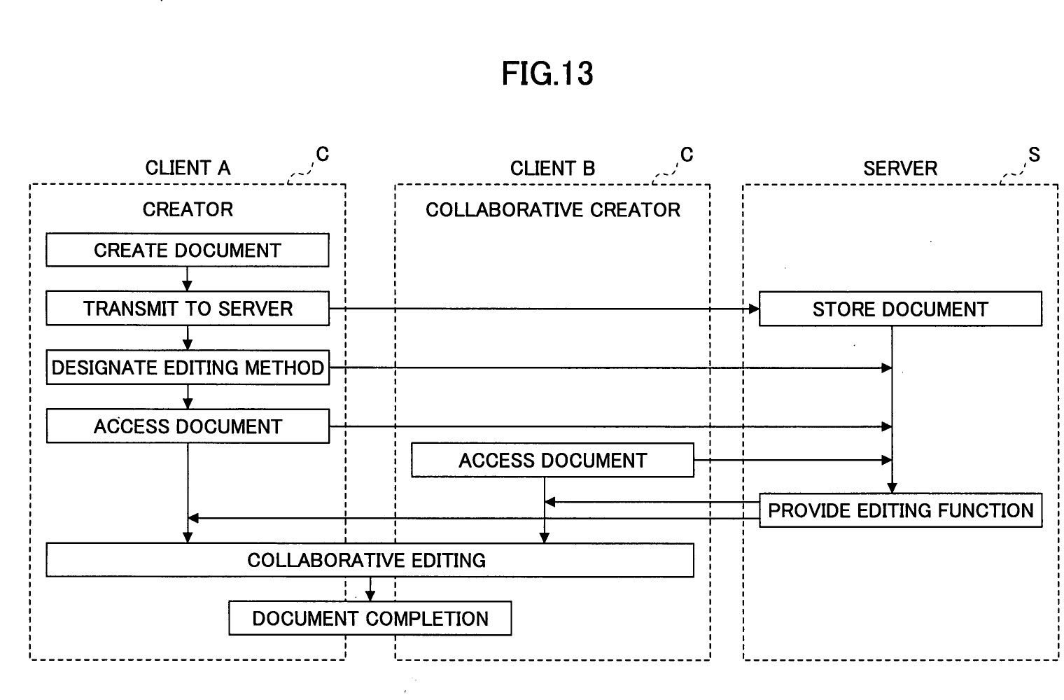

FIG. 13 is a flowchart illustrating an exemplary process flow from the creation to completion of a document in a collaborative document creating process realized in the server-client system as is described above. According to the illustrated example of FIG. 13, a creator creates a document using the client C (client A) corresponding to the document creating apparatus, and sends the created document to the server S to store the created document at the server S. The creator also designates an editing method to be implemented when the document stored in the server S is disclosed. Then, when a collaborative creator accesses the disclosed document using the client C (client B) and is authenticated, the server S provides the client C (client B) of the collaborative creator with an editing function that is designated by the creator beforehand. In turn, the collaborative creator uses the editing function provided by the server S to edit the document at the client C (client B). Similarly, when the creator accesses the disclosed document using the client C (client A) and is authenticated, the server S provides the client C (client A) with an editing function that is designated by the creator beforehand. In turn, the creator edits the disclosed document at the client C (client A) using the editing function provided by the server S. It is noted that in the present example, the editing function assignment 24 is realized by the server S. In this way, a document may be collaboratively created, edited, and completed.

5. Encapsulated Document

According to an embodiment of the present invention, an encapsulated document may be used to realize collaborative creation of a document by plural persons.

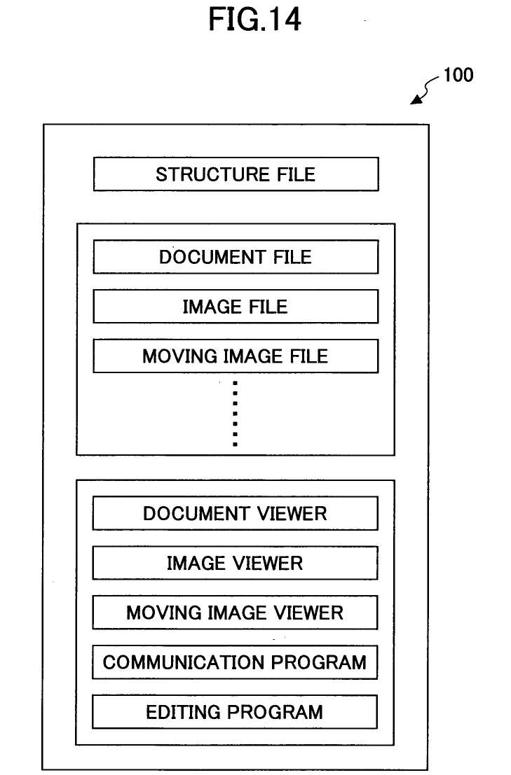

FIG. 14 is a diagram showing an exemplary configuration of an encapsulated document that includes program files for realizing a document transmitting function and a document editing function. The encapsulated document 100 shown in FIG. 14 includes a contents part including a document file describing the document content and multimedia files such as an image file and a moving image file attached to the document; a programs part including programs for viewing the contents of the document and programs for realizing operations such as transmission and editing of the document; and a structure file for administering the structure of the encapsulated document. In FIG. 14, a document viewer, an image viewer, and a moving image viewer correspond to programs for enabling viewing of the document contents contained within the encapsulated document 100; a communication program corresponds to a program for enabling transmission/reception of document information to/from another encapsulated document 100 to realize synchronization of the states of documents between plural encapsulated documents 100; and an editing program corresponds to a program for realizing the editing function according to the editing method designated by the editing method designation 22. As can be appreciated from the above descriptions, the encapsulated document 100 according to the present embodiment includes a designated editor. According to an embodiment, document is described using XML (eXtensible Markup Language), and the structure of the document, the programs to be used, the interrelation between the contents and programs, and URI (Uniform Resource Identifiers) indicating the storage location of the contents and programs may be described, for example. It is noted that the encapsulated document 100 may correspond to a ZIP archive file so that files may be easily changed or added to the encapsulated document 100. Also, a program file for displaying a dialog for prompting the designation of an editing method may be included in the encapsulated document 100.

According to an embodiment, peer-to-peer communication may be established between encapsulated documents 100 each having a program file with a document transmitting function. In this way, the states of the respective encapsulated documents 100 may be synchronized. For example, when a text is inserted at one of the encapsulated documents 100, this is automatically informed to the other encapsulated document 100 and the same text is inserted to the other encapsulated document 100 as well.

According to an embodiment, the encapsulated document 100 may be generated by printing a document to be included in the encapsulated document 100, analyzing the print command to generate a contents file, and encapsulating the contents file together with basic programs for viewing the contents file and extension programs.

Using the document transmitting function of the encapsulated document 100 as is described above, the encapsulated document 100 is transmitted (disclosed) from a computer 1 used by the creator of the encapsulated document 100 to a computer 1 used by a collaborative creator. The document transmission may be realized through various transmission means such as e-mail or FTP (File Transfer Protocol). In turn, the collaborative creator receiving the encapsulated document 100 from the creator, may activate this encapsulated document 100 and conduct editing operations thereon using the editing function assigned by the creator. According to the present embodiment, the states of the encapsulated document 100 at the creator side and the collaborative creator side are synchronized by the document transmitting function of the encapsulated document 100. Thus, even when differing editing functions are assigned to the creator and the collaborative creator, the states of the document at the respective sides are arranged to be the same. As for the synchronization method of the encapsulated document 100, for example, a technique disclosed in Japanese Laid-Open Patent Publication No. 2003-099303 may be used.

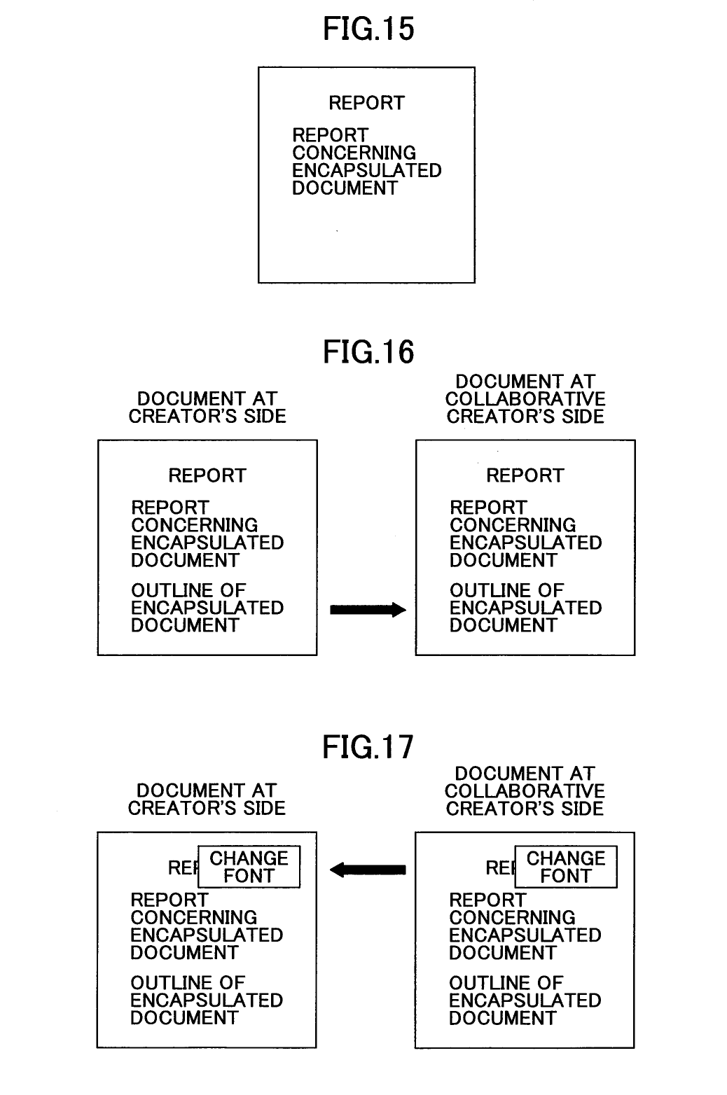

FIG. 15 is a diagram illustrating an exemplary content of a document file included in the encapsulated document 100 according to the present embodiment. In the example described below, it is assumed that the document content of FIG. 15 is transmitted (disclosed) to the computer 1 used by the collaborative creator, and ‘tag attachment’ is designated as the editing function to be assigned to the collaborative creator. According to the present example, by receiving and activating the encapsulated document 100, the collaborative creator is able to conduct document-editing operations based on the editing function assigned by the creator. In a situation where document editing operations can be conducted by both the document creator and the collaborative creator, when text is input by the document creator the input text information is transmitted to the collaborative creator through the communication program of the encapsulated document 100 each time a text item is set. For example, in a case where 1 byte characters such as alphabetic characters are input, since such characters are set one by one, text information is transmitted to the document on the collaborative creator side one character at a time by the communication program of the encapsulated document 100 along with associated information such as position information of the character within the document and font information of the character, for example. In a case where text in the form of Japanese characters is input that involves conversion of input characters into ‘Kana’ characters and Chinese characters, text information and its associated information such as position information and font information are transmitted to the document at the collaborative creator side by the communication program of the encapsulated document 100 each time a set of input text is converted and set. In turn, the communication program of the encapsulated document 100 at the collaborative creator side receives the transmitted information and reflects the received information on its corresponding document content. In this way, document content synchronization may be realized between the document creator side and the collaborative creator side. It is noted that document synchronization may also be realized in a similar manner when text is deleted. In a case where an object such as an image is inserted into the document content of the encapsulated document 100, and the communication program of the encapsulated document 100 transmits information pertaining to the inserted object (e.g., position information) to the encapsulated document 100 at the collaborative creator side. In turn, the communication program of the encapsulated document 100 at the collaborative creator side receives the transmitted information and reflects the received information on its corresponding document content to thereby realize document synchronization between the document creator side and the collaborative creator side.

FIG. 16 is a diagram illustrating a case in which document synchronization is realized between the document at the document creator side and the document at the collaborative creator side by using the communication function of the encapsulated document 100 at the document creator side to transmit information pertaining to edits on the document made by the document creator. Also, it is noted that in the present example, the collaborative creator is provided with a ‘tag attachment’ editing function.

FIG. 17 is a diagram illustrating a case in which document synchronization is realized between the document at the document creator side and the document at the collaborative creator side by using the communication function of the encapsulated document 100 at the collaborative creator side to transmit information pertaining to a tag attached to the document by the collaborative creator. According to the illustrated example, when the collaborative creator attaches a tag to the document, the communication program of the encapsulated document 100 at the collaborative creator side acquires information pertaining to the content of the tag and the position of the tag, for example, and transmits the acquired information to the encapsulated document 100 at the document creator side so that the tag may be attached to the document at the document creator side. According to the present example, an encapsulated document 100 with a restricted editing function is provided to the collaborative creator side, and an encapsulated document 100 with an unrestricted (full control) editing function is used at the document creator side so that detailed collaborative editing may be realized in a comprehensive manner.

It is noted that in the embodiments described above, a personal computer 1 is used as a terminal apparatus; however, the present invention is not limited to use of a personal computer, and for example, a PDA (Personal Digital Assistant) including a palm top PC, a mobile phone, and/or a PHS (Personal Handyphone System) may equally be used according to alternative embodiments of the present invention.

6. Features and Advantages

In the following, features and advantages of embodiments of the present invention are described.

According to an embodiment of the present invention, by setting a disclosure condition for a created document, the created document may be automatically disclosed when the set disclosure condition is satisfied. In this way, the document may be disclosed at an early stage, and a system for early disclosure of a document to a checker or a collaborative creator may be established so that errors and flaws in the document may be detected at an early stage to reduce the number of corrections to be made on the document, and to thereby reduce the burden of both the document creator and the checker or the collaborative creator, for example.

According to an embodiment of the present invention, by setting an editing method for a created document to be disclosed and setting an editing function for realizing the editing method to the created document, a predetermined level of editing authority may be assigned to one or more users other than the document creator (collaborative creator) according to the usage of the created document and/or the qualification or ability of the users (collaborative creators), and thereby, the created document may be shared and edited in a flexible manner.

According to an embodiment of the present invention, by individually setting a disclosure condition for each user (terminal apparatus), the created document may be set to be disclosed only to designated users, for example.

According to an embodiment of the present invention, by individually setting an editing method for each user (terminal apparatus) based on user information pertaining to each user, the editing method may be flexibly set according to the qualification and ability of each user, for example.

According to an embodiment of the present invention, by generating user information for a user (terminal apparatus) in a case where such information cannot be acquired, the user may be identified, and an editing method for such a user may be designated even when the user information is unavailable.

According to an embodiment of the present invention, by describing a storage location of the created document and transmitting this information to the collaborative creator, the collaborative creator may easily access the created document to thereby improve usability of the system.

According to an embodiment of the present invention, by informing the collaborative creator of the editing method he/she is authorized to use when the collaborative creator accesses the created document, the collaborative creator may be properly informed of his/her editing powers and confusion may be prevented so that usability of the system may be improved.

According to an embodiment of the present invention, by generating a message signaling that the same object is simultaneously being subject to editing by another terminal apparatus, conflict may be avoided between document creators that are given authority to add edits and/or change the contents and/or layout of a created document.

According to an embodiment of the present invention, by prohibiting an editing operation when the same object is simultaneously being subject to editing by another terminal apparatus, conflict may be avoided between document creators that are given authority to add edits and/or change the contents and/or layout of a created document.

According to an embodiment of the present invention, by fixing a position of an object currently subject to editing by a user upon reflecting the editing operation of another user, the user may be able to concentrate on his/her editing without being influenced by the editing operation simultaneously conducted by another user.

According to an embodiment of the present invention, by storing in a storage medium a program for realizing collaborative document creation according to an embodiment the present invention and installing/downloading the stored program to a computer, the program may be executed by the computer to realize one or more of the features and advantages of the embodiments of the present invention as is described above.

According to an embodiment of the present invention, by providing an encapsulated document including a document file of a created document, a basic program for viewing the document file, and a program for realizing collaborative document creation according to an embodiment of the present invention, for example, an encapsulated document with a restricted editing function may be transmitted to a collaborative creator and an encapsulated document with an unrestricted (full control) editing function may be used by the document creator so that collaborative editing may be realized in a comprehensive manner.

Further, the present invention is not limited to the embodiments described above, and variations and modifications may be made without departing from the scope of the present invention.

1. A document creating method for collaboratively creating a document by a plurality of persons using a plurality of terminal apparatuses that are interconnected via a network; the method comprising:
setting a disclosure condition for disclosing a document created at a first terminal apparatus of the terminal apparatuses to a second terminal apparatus of the terminal apparatuses;
setting an editing method for the document created at the first terminal apparatus;
setting an editing function for realizing the editing method to the document created at the first terminal apparatus; and
disclosing to the second terminal apparatus the document created by the first terminal apparatus with the editing function set thereto when the disclosure condition is satisfied.

2. The document creating method as claimed in claim 1, wherein:
the terminal apparatuses include a server and a plurality of clients that are connected to the server via the network;
at least one of the clients to
create a document and store the created document in the server,
set the disclosure condition for disclosing the document stored in the server;
set the editing method for the document stored in the server; and
set the editing function for realizing the editing method to the document stored in the server; and
the server to
store the document created by the at least one of the clients; and
disclose to the clients the stored document with the editing function set thereto when the disclosure condition is satisfied.

3. A document creating method for collaboratively creating a document by a plurality of persons using a plurality of terminal apparatuses that are connected via a network; the method comprising:
setting a disclosure condition for disclosing a document created at a first terminal apparatus of the terminal apparatuses to a second terminal apparatus of the terminal apparatuses; and
disclosing the document created at the first terminal apparatus to the second terminal apparatus when the disclosure condition is satisfied.

4. The document creating method as claimed in claim 3, wherein:
the terminal apparatuses include a server and a plurality of clients that are connected to the server via the network;
at least one of the clients to
create a document and store the created document in the server; and
set the disclosure condition for disclosing the document stored in the server; and
the server to
store the document created by the at least one of the clients; and
disclose the stored document to the clients when the disclosure condition is satisfied.

5. A document creating method for collaboratively creating a document by a plurality of persons using a plurality of terminal apparatuses that are connected via a network; the method comprising:
setting an editing method for a document created at a first terminal apparatus of the terminal apparatuses;
setting an editing function for realizing the editing method to the document created at the first terminal apparatus; and
disclosing to a second terminal apparatus of the terminal apparatuses the document created at the first terminal apparatus with the editing function set thereto.

6. The document creating method as claimed in claim 5, wherein:
the terminal apparatuses include a server and a plurality of clients that are connected to the server via the network;
at least one of the clients to
create a document and store the created document in the server,
set the editing method for the document stored in the server, and
set the editing function for realizing the editing method to the document stored in the server; and
the server to
store the document created by the at least one of the clients; and
disclose to the clients the stored document with the editing function set thereto.

7. A document creating apparatus that is connected to a terminal apparatus via a network in a network system and is adapted to realize collaborative creation of a document by a plurality of persons, the document creating apparatus comprising:
a disclosure condition setting unit to set a disclosure condition for disclosing a created document to the terminal apparatus;
an editing method setting unit to set an editing method for the created document; and
an editing function setting unit to set an editing function for realizing the editing method to the created document.

8. The document creating apparatus as claimed in claim 7, further comprising:
a disclosing unit to disclose to the terminal apparatus the created document with the editing function set thereto when the disclosure condition is satisfied.

9. The document creating apparatus as claimed in claim 7, wherein the network system includes a server to which the document creating apparatus and the terminal apparatus are connected via the network, the document creating apparatus further comprising:
a storing unit to store the created document in the server.

10. The document creating apparatus as claimed in claim 7, wherein the disclosure condition is set for each of a plurality of the terminal apparatuses.

11. The document creating apparatus as claimed in claim 7, further comprising:
a user information acquisition unit to acquire user information assigned to the terminal apparatus; wherein
the editing method is set for each of a plurality of the terminal apparatuses according to the user information assigned to each of the terminal apparatuses.

12. The document creating apparatus as claimed in claim 11, further comprising:
a user information generating unit to generate user information for the terminal apparatus when the user information acquisition unit fails to acquire the user information assigned to the terminal apparatus; and
a user information transmitting unit to transmit to the terminal apparatus the generated user information along with the editing method set for the terminal apparatus.

13. The document creating apparatus as claimed in claim 12, wherein a storage location of the created document is described and transmitted to the terminal apparatus along with the generated user information.

14. The document creating apparatus as claimed in claim 7, wherein the editing method is set according to user information of a user accessing the created document via the terminal apparatus, and the set editing method is signaled to the terminal apparatus.

15. The document creating apparatus as claimed in claim 7, wherein when editing is started on an object of the created document that is currently being edited by the terminal apparatus, a message is generated signaling that the object is currently being edited.

16. The document creating apparatus as claimed in claim 7, wherein when editing is started on an object of the created document that is currently being edited by the terminal apparatus, the started editing is prohibited.

17. The document creating apparatus as claimed in claim 7, wherein when editing is currently conducted on a first object of the created document and the terminal apparatus starts editing a second object of the created document at the same time, a position of the first object being edited is fixed upon reflecting the editing of the second object by the terminal apparatus.

18. A document creating apparatus that is connected to a terminal apparatus via a network in a network system and is adapted to realize collaborative creation of a document by a plurality of persons, the document creating apparatus comprising:
a disclosure condition setting unit to set a disclosure condition for disclosing a created document to the terminal apparatus.

19. The document creating apparatus as claimed in claim 18, further comprising:
a disclosing unit to disclose the created document to the terminal apparatus when the disclosure condition is satisfied.

20. The document creating apparatus as claimed in claim 18, wherein the network system includes a server to which the document creating apparatus and the terminal apparatus are connected via the network, the document creating apparatus further comprising:
a storing unit to store the created document in the server.

21. The document creating apparatus as claimed in claim 18, wherein the disclosure condition is set for each of a plurality of the terminal apparatuses.

22. The document creating apparatus as claimed in claim 18, wherein when editing is started on an object of the created document that is currently being edited by the terminal apparatus, a message is generated signaling that the object is currently being edited.

23. The document creating apparatus as claimed in claim 18, wherein when editing is started on an object of the created document that is currently being edited by the terminal apparatus, the started editing is prohibited.

24. The document creating apparatus as claimed in claim 18, wherein when editing is currently conducted on a first object of the created document and the terminal apparatus starts editing a second object of the created document at the same time, a position of the first object being edited is fixed upon reflecting the editing of the second object by the terminal apparatus.

25. A document creating apparatus that is connected to a terminal apparatus via a network in a network system and is adapted to realize collaborative creation of a document by a plurality of persons, the document creating apparatus comprising:
an editing method setting unit to set an editing method for a created document; and
an editing function setting unit to set an editing function for realizing the editing method to the created document.

26. The document creating apparatus as claimed in claim 25, further comprising:
a disclosing unit to disclose to the terminal apparatus the created document with the editing function set thereto.

27. The document creating apparatus as claimed in claim 25, wherein the network system includes a server to which the document creating apparatus and the terminal apparatus are connected via the network, the document creating apparatus further comprising:
a storing unit to store the created document in the server.

28. The document creating apparatus as claimed in claim 25, further comprising:
a user information acquisition unit to acquire user information assigned to the terminal apparatus; wherein
the editing method is set for each of a plurality of the terminal apparatuses according to the user information assigned to each of the terminal apparatuses.

29. The document creating apparatus as claimed in claim 28, further comprising:
a user information generating unit to generate user information for the terminal apparatus when the user information acquisition unit fails to acquire the user information assigned to the terminal apparatus; and
a user information transmitting unit to transmit to the terminal apparatus the generated user information along with the editing method set for the terminal apparatus.

30. The document creating apparatus as claimed in claim 29, wherein a storage location of the created document is described and transmitted to the terminal apparatus along with the generated user information.

31. The document creating apparatus as claimed in claim 25, wherein the editing method is set according to user information of a user accessing the created document via the terminal apparatus, and the set editing method is signaled to the terminal apparatus.

32. The document creating apparatus as claimed in claim 25, wherein when editing is started on an object of the created document that is currently being edited by the terminal apparatus, a message is generated signaling that the object is currently being edited.

33. The document creating apparatus as claimed in claim 25, wherein when editing is started on an object of the created document that is currently being edited by the terminal apparatus, the started editing is prohibited.

34. The document creating apparatus as claimed in claim 25, wherein when editing is currently conducted on a first object of the created document and the terminal apparatus starts editing a second object of the created document at the same time, a position of the first object being edited is fixed upon reflecting the editing of the second object by the terminal apparatus.

35. A computer-readable program that is run on a computer implemented in a document creating apparatus that is connected to a terminal apparatus via a network in a network system and is adapted to realize collaborative creation of a document by a plurality of persons, the program being executed by the computer to perform a method comprising:
setting an editing method for a created document; and
setting an editing function for realizing the editing method to the created document.

36. A storage medium storing a computer-readable program that is run on a computer implemented in a document creating apparatus, which document creating apparatus is connected to a terminal apparatus via a network in a network system and is adapted to realize collaborative creation of a document by a plurality of persons, the program being executed by the computer to perform a method comprising:
setting a disclosure condition for disclosing a created document to the terminal apparatus;
setting an editing method for the created document; and
setting an editing function for realizing the editing method to the created document.

37. The storage medium as claimed in claim 35, wherein the method further comprises:
disclosing to the terminal apparatus the created document with the editing function set thereto when the disclosure condition is satisfied.

38. The storage medium as claimed in claim 35, wherein:
the network system includes a server to which the document creating apparatus and the terminal apparatus are connected via the network; and
the method further comprises storing the created document in the server.

39. The storage medium as claimed in claim 35, wherein the disclosure condition is set for each of a plurality of the terminal apparatuses.

40. The storage medium as claimed in claim 35, wherein:
the method further comprises acquiring user information assigned to the terminal apparatus; and
the editing method is set for each of a plurality of the terminal apparatuses according to the user information assigned to each of the terminal apparatuses.

41. The storage medium as claimed in claim 40, wherein the method further comprises:
generating user information for the terminal apparatus when the user information assigned to the terminal apparatus is not acquired when acquiring user information assigned to the terminal apparatus; and
transmitting to the terminal apparatus the generated user information along with the editing method set for the terminal apparatus.

42. The storage medium as claimed in claim 41, wherein a storage location of the created document is described and transmitted to the terminal apparatus along with the generated user information.

43. The storage medium as claimed in claim 35, wherein the editing method is set according to user information of a user accessing the created document via the terminal apparatus, and the set editing method is signaled to the terminal apparatus.

44. The storage medium as claimed in claim 35, wherein when editing is started on an object of the created document that is currently being edited by the terminal apparatus, a message is generated signaling that the object is currently being edited.

45. The storage medium as claimed in claim 35, wherein when editing is started on an object of the created document that is currently being edited by the terminal apparatus, the started editing is prohibited.

46. The storage medium as claimed in claim 35, wherein when editing is currently conducted on a first object of the created document and the terminal apparatus starts editing a second object of the created document at the same time, a position of the first object being edited is fixed upon reflecting the editing of the second object by the terminal apparatus.

47. A storage medium storing a computer-readable program that is run on a computer implemented in a document creating apparatus, which document creating apparatus is connected to a terminal apparatus via a network in a network system and is adapted to realize collaborative creation of a document by a plurality of persons, the program being executed by the computer to perform a method comprising:
setting a disclosure condition for disclosing a created document to the terminal apparatus.

48. The storage medium as claimed in claim 47, wherein the method further comprises:
disclosing the created document to the terminal apparatus when the disclosure condition is satisfied.

49. The storage medium as claimed in claim 47, wherein:
the network system includes a server to which the document creating apparatus and the terminal apparatus are connected via the network; and
the method further comprises storing the created document in the server.

50. The storage medium as claimed in claim 47, wherein the disclosure condition is set for each of a plurality of the terminal apparatuses.

51. The storage medium as claimed in claim 47, wherein when editing is started on an object of the created document that is currently being edited by the terminal apparatus, a message is generated signaling that the object is currently being edited.

52. The storage medium as claimed in claim 47, wherein when editing is started on an object of the created document that is currently being edited by the terminal apparatus, the started editing is prohibited.

53. The storage medium as claimed in claim 47, wherein when editing is currently conducted on a first object of the created document and the terminal apparatus starts editing a second object of the created document at the same time, a position of the first object being edited is fixed upon reflecting the editing of the second object by the terminal apparatus.

54. A storage medium storing a computer-readable program that is run on a computer implemented in a document creating apparatus, which document creating apparatus is connected to a terminal apparatus via a network in a network system and is adapted to realize collaborative creation of a document by a plurality of persons, the program being executed by the computer to perform a method comprising:
setting an editing method for a created document; and
setting an editing function for realizing the editing method to the created document.

55. The storage medium as claimed in claim 54, wherein the method further comprises:
disclosing to the terminal apparatus the created document with the editing function set thereto.

56. The storage medium as claimed in claim 54, wherein:
the network system includes a server to which the document creating apparatus and the terminal apparatus are connected via the network; and
the method further comprises storing the created document in the server.

57. The storage medium as claimed in claim 53, wherein:
the method further comprises acquiring user information assigned to the terminal apparatus; and
the editing method is set for each of a plurality of the terminal apparatuses according to the user information assigned to each of the terminal apparatuses.

58. The storage medium as claimed in claim 57, wherein the method further comprises:
generating the user information for the terminal apparatus when the user information assigned to the terminal apparatus is not acquired in acquiring the user information assigned to the terminal apparatus; and
transmitting to the terminal apparatus the generated user information along with the editing method set for the terminal apparatus.

59. The storage medium as claimed in claim 58, wherein a storage location of the created document is described and transmitted to the terminal apparatus along with the generated user information.

60. The storage medium as claimed in claim 54, wherein the editing method is set according to user information of a user accessing the created document via the terminal apparatus, and the set editing method is signaled to the terminal apparatus.

61. The storage medium as claimed in claim 54, wherein when editing is started on an object of the created document that is currently being edited by the terminal apparatus, a message is generated signaling that the object is currently being edited.

62. The storage medium as claimed in claim 54, wherein when editing is started on an object of the created document that is currently being edited by the terminal apparatus, the started editing is prohibited.

63. The storage medium as claimed in claim 54, wherein when editing is currently conducted on a first object of the created document and the terminal apparatus starts editing a second object of the created document at the same time, a position of the first object being edited is fixed upon reflecting the editing of the second object by the terminal apparatus.

64. A data structure of an encapsulated document comprising:
a document file of a created document;
a program for viewing the document file; and
a computer-readable program that is run on a computer implemented in a document creating apparatus that is connected to a terminal apparatus via a network in a network system and is adapted to realize collaborative creation of a document by a plurality of persons, the program being executed by the computer to perform a method comprising setting a disclosure condition for disclosing the created document to the terminal apparatus, setting an editing method for the created document, and setting an editing function for realizing the editing method to the created document.

65. A data structure of an encapsulated document comprising:
a document file of a created document;
a program for viewing the document file; and
a computer-readable program that is run on a computer implemented in a document creating apparatus that is connected to a terminal apparatus via a network in a network system and is adapted to realize collaborative creation of a document by a plurality of persons, the program being executed by the computer to perform a method comprising setting a disclosure condition for disclosing the created document to the terminal apparatus.

66. A data structure of an encapsulated document comprising:
a document file of a created document;
a program for viewing the document file; and
a computer-readable program that is run on a computer implemented in a document creating apparatus that is connected to a terminal apparatus via a network in a network system and is adapted to realize collaborative creation of a document by a plurality of persons, the program being executed by the computer to perform the steps of setting an editing method for the created document, and setting an editing function for realizing the editing method to the created document.
